(19) United States
(12) Patent Application Publication
(10) Pub. No.: US 2003/0200286 A1
(43) Pub. Date: Oct. 23, 2003

(54) Methods and systems for providing configuration data

(75) Inventors: Joerg Barfurth, Hechthousen (DE); Joerg Heilig, Hamburg (DE)

Correspondence Address: SONNENSCHEIN NATH & ROSENTHAL LLP, P.O. BOX 061080, WACKER DRIVE STATION, SEARS TOWER, CHICAGO, IL, 60606-1080, US

(73) Assignee: Sun Microsystems, Inc.

(21) Appl. No.: 10/383,979

(22) Filed: Mar. 7, 2003

(30) Foreign Application Priority Data
Mar. 8, 2002 (EP) 02005250.2

(51) Int. Cl. G06F 15/177

(52) U.S. Cl. 709/220; 713/1

(57) ABSTRACT

Methods, systems, and articles of manufacture provide configuration data from a configuration server to a client. The configuration server receives a request to provide a value for a configuration data item. The configuration server then determines a set to which the configuration item is assigned, with the set being associated with a rule. Then, the configuration server determines a value of the configuration item by applying the rule associated with the set and transmits the determined value of the configuration item to the client.

### CROSS-REFERENCE TO RELATED APPLICATIONS

This Application claims the benefit of the filing date and priority to the following foreign patent application, which is incorporated herein by reference to the extent permitted by law:

European Patent Application serial number 02005250.2, entitled “MANAGING MULTIPARAMETRIC LAYERED CONFIGURATIONS USING DISJOINT DIMENSIONS”, filed Mar. 8, 2002.

1. Field of the Invention

The present invention relates to a method and system for providing configuration data values in a client/server data processing environment.

2. Background of the Invention

As is known, users use a variety of devices to access services via communication networks, such as telephone networks or the Internet. The services are provided by servers on the networks. The users' devices can be, for example, personal computers, workstations, personal digital assistants, or mobile phones. These devices communicate as client devices with the servers via the networks and access services including software and content.

To provide the services to different users using different client devices so that an individual user may use any service on a variety of client devices in an individualized manner, the servers typically employ a configuration server that provides configuration data to the client device. The configuration data includes information specific to the user and client device that is used by the client device to personalize the service for the user and the client device. For example, the configuration data can include a number of configuration items that define the client device's display height (e.g., 768 pixels), the client device's display width (e.g., 1024 pixels), and the user's ability to run a macro (e.g., Edit Macro/Enabled=True).

These configuration items are stored in a hierarchical system or structure, which is typically a tree structure. Both the server and the client are aware of the configuration data's structure, although the client may be aware of only a subset of the configuration data known to the server or vice versa. Adding additional parameters that are used to determine the values of configuration items conventionally requires modifying the data structure by introducing additional levels for those parameters. In an example, a data structure includes levels for the display width and display height, but does not include a level for the user's location. In order for the configuration server to provide configuration data by taking into consideration the user's location, a new level for the user's location would typically need to be added to the data structure. Although these modifications are generally performed at the configuration server, modifications of this kind conventionally also require making modifications to each client and possibly to the services.

### SUMMARY OF THE INVENTION

Methods, systems, and articles of manufacture consistent with the present invention provide for introducing new parameters or new dependencies among configuration data on a configuration server, without having to amend the configuration data's structure. The configuration data is stored on a configuration server and comprises a number of configuration items (i.e., configuration information) that are used by a client device to personalize a service for the client device and its user. In an example, the user operates a palmtop computing device to retrieve e-mail. The configuration server includes configuration items, such as the size of the user's video display height and width, that are used by the palmtop computing device to personalize the e-mail retrieval for the user.

The configuration server comprises a configuration program that determines appropriate values for the configuration items and provides those values to the client device. The configuration items are stored on the configuration server in a database, and each configuration item is assigned to a dimension, which is a set of configuration items. For example, a first dimension can include configuration items relating to a user's ability to edit and a second dimension can include configuration items relating to the client device's display characteristics. In turn, each dimension is associated with at least one rule that the configuration program applies to determine the values of the configuration items of the dimension. A rule is a code piece, such as a function or module, that is called by the configuration program to determine a value for a particular configuration item. The rule looks up the configuration item in a database table by taking into consideration criteria defined in the rule and parameters submitted by the client. For example, a rule that is called to retrieve a value for the user's display device width uses parameters received from the user that identify the user's name as “Anne” and the user's device type as “Palmtop” in order to retrieve the value “1024.”

The configuration program receives parameters and requests for configuration items from the client device via a network. When the configuration program receives such a request, it first determines a dimension to which the configuration item is assigned. Then, the configuration program determines the value of the configuration item by invoking the rule associated with that dimension. As noted above, when the configuration program invokes the rule, the rule can use one or more parameters received from the client device. The parameters comprise information that is external to the configuration's data structure and that does not include the configuration items. Therefore, the configuration program can determine configuration item values using the received parameters, which are not part of the configuration data's structure.

For example, in the case where the user wants to obtain a value for the user's display device width, the user sends to the configuration program parameters for the user's name (e.g., “Anne”) and the user's device type (e.g., “Palmtop”). The configuration program determines the dimensions to which the configuration items for language preference is assigned. Knowing this dimension, the configuration program invokes the rule associated with that dimension to determine the value for the language preference. The rule retrieves the value “1024” from a database table by taking into consideration the parameters “Anne” and “Palmtop,” and returns the value to the configuration program. Then, the configuration program transmits the value “1024” to the client.

In a conventional configuration server, the configuration data's structure includes a level for each criterion that is considered when determining a configuration item's value. In the above-described example, the conventional data structure would require levels for the user's display device width, as well as the user's name and device type. Also, if an additional criterion, such as the user's language (e.g., “English”) is to be considered, then the conventional data structure would need to be modified to include a level for the user's language.

For methods, systems, and articles of manufacture consistent with the present invention, however, the data structure would not need to be modified. Instead, the data structure includes a level for the user's display device width, and parameters are received for the user's name, device type, and language. The rule associated with determining the user's display device width uses these parameters when retrieving a value for the display device width from the database table. Therefore, a greater degree of flexibility is achieved for providing configuration data, since criteria (i.e., parameters) outside the data structure are considered when retrieving data items. This flexibility is further achieved since the assignment of configuration items to dimensions is configurable as well as the relation of dimensions, rules, and parameters. For example, configuration items can be assigned to new dimensions so that values for those configuration items can be based on new rules and parameters.

In accordance with methods consistent with the present invention, a method in a configuration server having a program for providing configuration data to a client is provided. The configuration data comprises at least one configuration item having a value. The method comprises the steps of: receiving a request to provide the value for the configuration item; determining a dimension to which the configuration item is assigned, the dimension being associated with a rule; determining a value of the configuration item by applying the rule associated with the dimension; and transmitting the determined value of the configuration item to the client.

In accordance with methods consistent with the present invention, a method in a configuration server having a program for providing configuration data to a client is provided. The configuration data comprises at least one configuration item having a value. The method comprises the steps of: receiving a user identification information from the client; receiving a request to provide values of the device type of the client and the display type of the client; determining one of a plurality of sets to which the device type and the display type are respectively assigned, the sets each being associated with a respective rule; determining a value of the device type based on the rule associated with the determined set to which the device type is assigned by using the user identification information; determining a value of the display type based on the rule associated with the set to which the display type is assigned by using the user identification information; and transmitting the determined values of the device type and display type to the client.

In accordance with articles of manufacture consistent with the present invention, a computer-readable medium is provided. The computer-readable medium contains instructions that cause a program for providing configuration data to a client, the configuration data comprises at least one configuration item having a value, to perform a method comprising the steps of: receiving a request to provide the value for the configuration item; determining a set to which the configuration item is assigned, the set being associated with a rule; determining a value of the configuration item by applying the rule associated with the set; and transmitting the determined value of the configuration item to the client.

In accordance with articles of manufacture consistent with the present invention, a computer-readable medium is provided. The computer-readable medium contains instructions that cause a program for providing configuration data to a client, the configuration data comprising at least one configuration item having a value, to perform a method comprising the steps of: receiving a user identification information from the client; receiving a request to provide values of the device type of the client and the display type of the client; determining one of a plurality of sets to which the device type and the display type are respectively assigned, the sets each being associated with a respective rule; determining a value of the device type based on the rule associated with the determined set to which the device type is assigned by using the user identification information; determining a value of the display type based on the rule associated with the set to which the display type is assigned by using the user identification information; and transmitting the determined values of the device type and display type to the client.

In accordance with systems consistent with the present invention, a configuration server is provided for providing configuration data to a client, the configuration data comprising at least one configuration item having a value. The configuration server comprises: a memory comprising a program that receives a request to provide the value for the configuration item, determines a set to which the configuration item is assigned, the set being associated with a rule, determines a value of the configuration item by applying the rule associated with the set, and transmits the determined value of the configuration item to the client; and a processing unit that runs the program.

In accordance with systems consistent with the present invention, a configuration server is provided for providing configuration data to a client, the configuration data comprising at least one configuration item having a value. The configuration server comprises: means for receiving a request to provide the value for the configuration item; means for determining a set to which the configuration item is assigned, the set being associated with a rule; means for determining a value of the configuration item by applying the rule associated with the set; and means for transmitting the determined value of the configuration item to the client.

In accordance with articles of manufacture consistent with the present invention, a computer-readable memory device is provided. The computer-readable memory device is encoded with a program having a data structure. The program is run by a processor of a configuration server in a data processing system having a client. The data structure has a plurality of entries, each entry comprising: a configuration item value that is requested by the client and that is returned to the client by determining a set to which the configuration item is assigned, the set being associated with a rule, and determining a value of the configuration item by applying the rule associated with the set.

In accordance with methods consistent with the present invention, a method in a configuration server having a data structure including a plurality of configuration items, each configuration item having a value, is provided. The method comprises the steps of: receiving from a client a first request to obtain the value for one of the configuration items in the data structure, the data structure having a set of predefined relationships between the data items; returning to the client the value of the one configuration item; receiving from the client a second request to obtain the value from the one configuration item in the data structure, the data structure having an additional relationship between the data items that is imposed through a mechanism that is external with respect to the data structure; and returning to the client the value of the one configuration item.

In accordance with articles of manufacture consistent with the present invention, a computer-readable medium is provided that contains instructions that cause a program in a configuration server having a data structure including a plurality of configuration items, each configuration item having a value, to perform a method comprising the steps of: receiving from a client a first request to obtain the value for one of the configuration items in the data structure, the data structure having a set of predefined relationships between the data items; returning to the client the value of the one configuration item; receiving from the client a second request to obtain the value from the one configuration item in the data structure, the data structure having an additional relationship between the data items that is imposed through a mechanism that is external with respect to the data structure; and returning to the client the value of the one configuration item.

In accordance with systems consistent with the present invention, a configuration server for providing configuration data to a client, the configuration server having a data structure including a plurality of configuration items, each configuration item having a value, is provided. The configuration server comprises: a memory comprising a program that receives from a client a first request to obtain the value for one of the configuration items in the data structure, the data structure having a set of predefined relationships between the data items, returns to the client the value of the one configuration item, receives from the client a second request to obtain the value from the one configuration item in the data structure, the data structure having an additional relationship between the data items that is imposed through a mechanism that is external with respect to the data structure, and returns to the client the value of the one configuration item; and a processing unit that runs the program.

Other systems, methods, features, and advantages of the invention will become apparent to one with skill in the art upon examination of the following figures and detailed description. It is intended that all such additional systems, methods, features, and advantages be included within this description, be within the scope of the invention, and be protected by the accompanying drawings.

### BRIEF DESCRIPTION OF THE DRAWINGS

The accompanying drawings, which are incorporated in and constitute a part of this specification, illustrate an implementation of the invention and, together with the description, serve to explain the advantages and principles of the invention. In the drawings,

FIG. 1 shows a block diagram of a data processing system suitable for use with methods and systems consistent with the present invention;

FIG. 2 shows a block diagram of a data structure suitable for use with methods and systems consistent with the present invention; and

FIG. 3 depicts a flow diagram illustrating the steps performed by the configuration program for providing configuration data in accordance with methods and systems consistent with the present invention.

### DETAILED DESCRIPTION OF THE INVENTION

Reference will now be made in detail to an implementation consistent with the present invention as illustrated in the accompanying drawings. Wherever possible, the same reference numbers will be used throughout the drawings and the following description to refer to the same or like parts.

Overview

Methods, systems, and articles of manufacture consistent with the present invention provide for introducing new parameters or new dependencies among configuration data on a configuration server, without having to amend the configuration data's structure. The configuration data is stored on a configuration server and comprises a number of configuration items (i.e., configuration information) that are used by a client device to personalize a service for the client device and its user. In an illustrative example, a user, Anne, operates a palmtop computing device to retrieve payroll information from a payroll server. The configuration server includes configuration items, such as Anne's ability to access the payroll information (e.g., True) and the size of Anne's video display (e.g., 1024×768), that are used by the palmtop computing device to personalize the retrieval of payroll information for Anne.

The configuration server comprises a configuration program that determines appropriate values for the configuration items and provides those values to the client device. The configuration items are stored on the configuration server in a database, and each configuration item is assigned to a dimension, which is a set of configuration items. In the illustrative example, one dimension includes configuration items relating to Anne's language preference and another dimension includes configuration items relating to Anne's palmtop computing device's video display. In turn, each dimension is associated with at least one rule that the configuration program applies to determine the values of the configuration items of the dimension. A rule is a code piece, such as a function or module, that is called by the configuration program to determine a value for a particular configuration item. The rule looks up the configuration item in a database table by taking into consideration criteria defined in the rule and parameters submitted by the client. For example, a rule that is called to retrieve a value for Anne's video display width can use parameters that identify Anne's name as “Anne” and Anne's device type as “Palmtop” in order to retrieve the value “1024”.

The configuration program receives parameters and requests for configuration items from the client device via a network. When the configuration program receives such a request, it first determines a dimension to which the configuration item is assigned. Then, the configuration program determines the value of the configuration item by invoking the rule associated with that dimension. As noted above, when the configuration program invokes the rule, the rule can use one or more parameters received from the client device. Therefore, the configuration program can determine configuration item values using the received parameters, which may not be a part of the configuration data's structure.

In the illustrative example, Anne sends to the configuration program parameters for the user's name (i.e., “Anne”) and the user's device type (i.e., “Palmtop”). Anne also sends a request for a configuration item value for Anne's display device width. The configuration program determines the dimensions to which the configuration item for display device width is assigned. Knowing this dimension, the configuration program invokes the rule associated with that dimension to determine the value for the display device width. The rule retrieves the value “1024” from a database table by taking into consideration the parameters “Anne” and “Palmtop,” and returns the value to the configuration program. Then, the configuration program transmits the value “1024” to Anne's palmtop computing device.

Therefore, unlike a conventional configuration server, methods, systems, and articles of manufacture consistent with the present invention use criteria outside of the configuration data's structure when providing configuration item values. Configuration item values are provided by taking into consideration parameters that are not defined as levels within the data structure, and therefore, the data structure does not have to be modified.

Implementation Details

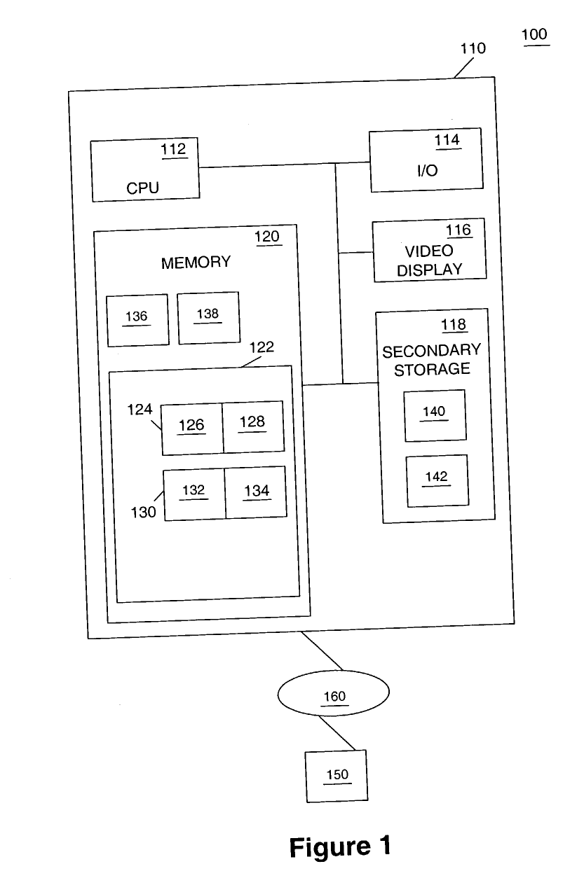

Referring to FIG. 1, FIG. 1 depicts a block diagram of a data processing system 100 suitable for use with methods and systems consistent with the present invention. Data processing system 100 comprises a configuration server 110 communicating with a client 150 via a network 160. The configuration server comprises a central processing unit (CPU) 112, an input output I/O unit 114, display device 116, a secondary storage device 118, and a memory 120. Configuration server 110 may further comprise standard input devices such as a keyboard, a mouse or a speech processing means (each not illustrated).

Memory 120 contains a configuration program 122 for providing configuration data to the client. As will be described in more detail below, the configuration program 122 receives a client request to provide a value for a configuration item, determines a value for the requested configuration item, and transmits the determined value to the client. The configuration program comprises a communication module 124 for communicating with the client via the network. The communication module includes a code section for receiving information 126, for example the above mentioned request, from the client and a code section for transmitting information 128, for example for transmitting the determined values for the requested configuration items to the client via the network. The communication module may be adapted to allow simultaneous communication between the configuration server and more than one client.

One having skill in the art will appreciate that the term “client,” as used herein, can also describe a server acting as a client when communicating with configuration server 110. Further, any device that sends a request to the configuration server requesting configuration data is a client for purposes of this disclosure.

The configuration program further comprises a retrieving module 130 for retrieving values for the configuration items from, for example, the secondary storage device. The retrieving module includes a code section 132 for determining a dimension to which a configuration item is assigned and a code section 143 for determining a value for a configuration item by applying a rule associated with the dimension of the respective configuration item. The modules and code sections described herein may be combined into one or more modules or code sections suitable to perform the tasks described herein.

The configuration program, which will be described in more detail below, may comprise or may be included in one or more code sections containing instructions for performing their respective operations. While the configuration program is described as being implemented as software, the present implementation may be implemented as a combination of hardware and software or hardware alone. Moreover, the configuration program may be a combination of programs, modules, threads, processes or any other software construct. Also, one having skill in the art will appreciate that configuration program may comprise or may be included in a data processing device, which may be a client or a server, communicating with the data processing system.

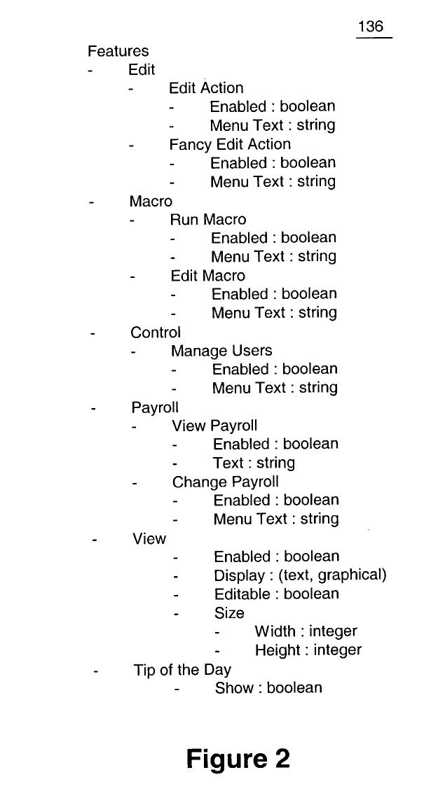

The configuration program includes a tree data structure 136, which is shown in more detail in FIG. 2. Referring to FIG. 2, the data structure has a plurality of entries, each entry comprising a configuration item value requested by the client and determined by determining a set to which the configuration item is assigned, the set being associated with a rule, and determining a value of the configuration item by applying the rule associated with the set.

Referring back to FIG. 1, secondary storage 118 includes a data structure 140 of the configuration data and an assignment database 142, which identifies for each configuration item its dimension, rule for that dimension, and potential configuration item values. The data structure and the assignment database will be described in more detail below. The assignment database may be implemented as any form of database, such as a flat file database, a table-oriented database, a relational database, or an object-oriented database, or another form of database. While the assignment database is shown as being located in the secondary storage, it may be stored at another location, such as in memory or on a remote server. Also, while assignment database tables are described below with reference to the illustrative example, one having skill in the art will appreciate that methods, systems, and articles of manufacture consistent with the present invention are not limited to the described tables.

Although aspects of methods, systems, and articles of manufacture consistent with the present invention are depicted as being stored in memory, one having skill in the art will appreciate that these aspects may be stored on or read from other computer-readable media, such as secondary storage devices, like hard disks, floppy disks, and CD-ROMs; a carrier wave received from a network such as the Internet; or other forms of ROM or RAM either currently known or later developed. Further, although specific components of data processing system 100 have been described, one having skill in the art will appreciate that a data processing system suitable for use with methods, systems, and articles of manufacture consistent with the present invention may contain additional or different components.

One having skill in the art will also appreciate that the server can itself also be implemented as a client-server data processing system. In that case, the configuration program can be stored on the configuration server as a client, while some or all of the steps of the processing described below can be carried out on a remote server, which is accessed by the configuration server over the network. The remote server can comprise components similar to those described above with respect to the configuration server, such as a CPU, an I/O, a memory, a secondary storage, and a display device.

The network can be any network suitable for use with methods and systems consistent with the present invention, such as a Local Area Network, Wide Area Network, or the Internet.

Client 150 can be any client device suitable for use with methods and systems consistent with the present invention. The client comprises components similar to those described above with respect to the configuration server, such as a CPU, an I/O, a memory, a display device, and possibly a secondary storage. The client can be, but is not limited to, for example, a computer, a mobile phone, a telephone, a handheld device, a palmtop computing device, or a set top box.

As described above, in the illustrative example, the client device is a palmtop computing device operated by the user (i.e., Anne), who wants to retrieve specific configuration data relating to her palmtop computing device. One having skill in the art will appreciate that this example is merely illustrative, and that methods, systems, and articles of manufacture consistent with the present invention are not limited thereto. For example, in the illustrative example, the user sends certain parameters to the configuration program and the assignment database comprises certain database tables. One having skill in the art will appreciate that these items are provided for illustrative purposes and that the invention is not limited thereto.

In the illustrative example, the user sends to the configuration program, on the configuration server, a number of parameters describing herself and her client device (i.e., her palmtop device). Anne sends the following parameters:

User-ID=Anne

Client Type=Palmtop

Connection Properties=(LAN, secure, high-bandwidth, low-latency)

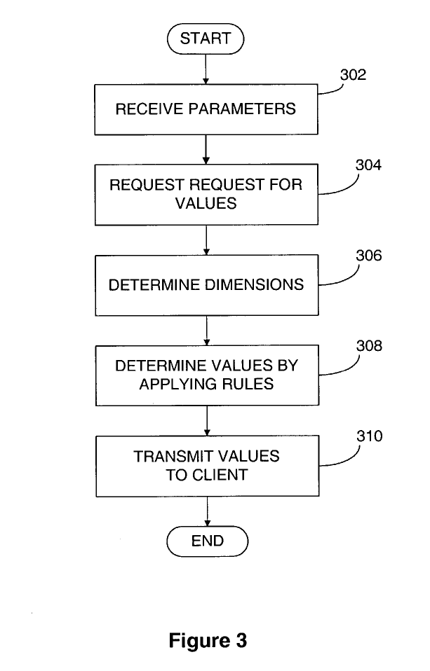

The significance of these parameters and their values will be described in more detail below. In the illustrative example, Anne also sends a request for configuration data to the configuration program. The configuration data has a predetermined data structure comprising a plurality of configuration items. In the illustrative example, the configuration program returns values for each of the configuration items of the data structure, however, the configuration program can alternatively return values for less than all of the configuration items. The exemplary steps performed by the configuration program are described in more detail below with reference to FIG. 3, however, an initial description of the data structure for the illustrative example is initially described.

In the illustrative example, the data structure has a tree-type structure as shown below.

Features

Edit

Edit Action

Enabled: boolean
Menu Text: string

Fancy Edit Action

Enabled: boolean
Menu Text: string

Macro

Run Macro

Enabled: boolean
Menu Text: string

Edit Macro

Enabled: boolean
Menu Text: string

Control

Manage Users

Enabled: boolean
Menu Text: string

Payroll

View Payroll

Enabled: boolean
Text: string

Change Payroll

Enabled: boolean
Menu Text: string

View

Enabled: boolean
Display: (text, graphical)
Editable: boolean
Size

Width: integer
Height: integer

Tip of the Day

Show: boolean

### ILLUSTRATIVE EXAMPLE DATA STRUCTURE

One having skill in the art will appreciate that the above-described data structure is merely illustrative, and that a data structure in accordance with methods, systems and articles of manufacture consistent with the present invention is not limited to a tree-type structure or to a data structure having the illustrative example's values. Each configuration item of the illustrative data structure is defined by its position in the data structure and by the data type that is indicated by being separated by a colon. Therefore, the above data structure comprises the following individual configuration items:

Features/Edit/Edit Action/Enabled

Features/Edit/Edit Action/Text

Features/Edit/Fancy Edit Action/Enabled

Features/Edit/Fancy Edit Action/Text

Features/Macro/Run Macro/Enabled

Features/Macro/Run Macro/Text

Features/Macro/Edit Macro/Enabled

Features/Macro/Edit Macro/Text

Features/Control/Manage Users/Enabled

Features/Control/Manage Users/Text

Features/Payroll/View Payroll/Enabled

Features/Payroll/View Payroll/Text

Features/Payroll/Change Payroll/Enabled

Features/Payroll/Change Payroll/Text

Features/View/Enabled

Features/View/Display

Features/View/Editable

Features/View/Size/Width

Features/View/Size/Height

Features/Tip of the Day/Shown

It becomes apparent from the above list of configuration items that the data structure is the structured representation of the configuration items as shown in the above list.

FIG. 3 depicts a flow diagram 300 illustrating exemplary steps performed by the configuration program for providing values of requested configuration items to the client. First, the configuration program receives one or more parameters from the client (step 302). As described above, in the illustrative example, Anne sends the following parameters, which are received by the configuration program in step 302:

User-ID=Anne

Client Type=Palmtop

Connection Properties=(LAN, secure, high-bandwidth, low-latency)

The client may transmit the parameters, for example, during an initial phase of communication with the configuration server or at a later time. For example, the client may transmit the parameters during a log-on phase that is used by the configuration server to identify or authorize the client.

Then, the configuration program receives from the client a request to provide values for one or more configuration items (step 304). As stated above, in the illustrative example, the configuration program receives a request for values for each configuration item of the data structure. One having skill in the art will appreciate that the format of the request will vary depending on, for example, the communication protocol that the client device and the configuration program use. In the illustrative example, the palmtop computing device and the configuration program communicate using the Universal Network Objects (UNO) protocol. UNO is manufactured by OpenOffice.org.

The configuration program then determines the dimensions to which the respective configuration items are assigned (step 306). As noted above, each configuration item is assigned to one or more dimensions (i.e., sets of configuration items). As will be described in more detail below, each dimension is in turn associated with at least one rule for determining the values of the respective configuration items in the dimension. The configuration program determines a dimension to which a configuration item is assigned by finding the configuration item in an assignment database table of configuration item/dimension assignments. The configuration program may make the determination in alternate ways, such as, by analyzing pointers associated with the configuration items.

In the following, the illustrative configuration items are shown assigned to a dimension in an illustrative configuration assignment table (Table 1).

TABLE 1

| Configuration Item | Dimension |
|---|---|
| Features/Tip of the Day/Show | Default |
| Features/View/Display | DeviceCaps |
| Features/View/Editable | |
| Features/View/Size/Width | DevicePrefs |
| Features/View/Size/Height | |
| Features/Edit/Edit Action/Enabled | Function |
| Features/Edit/Fancy Edit Action/Enabled | |
| Features/Macro/Run Macro/Enabled | |
| Features/Macro/Wit Macro/Enabled | |
| Features/Control/Manage Users/Enabled | |
| Features/View/Enabled | |
| Features/Payroll/View Payroll/Enabled | Level |
| Features/Payroll/Change Payroll/Enabled | |
| Features/Edit/Edit Action/Menu Text | Language |
| Features/Edit/Fancy Edit/Action/Menu Text | |
| Features/Macro/Run Macro/Menu Text | |
| Features/Macro/Edit Macro/Menu Text | |
| Features/Control/Manage Users/Menu Text | |
| Features/Payroll/View Payroll/Menu Text | |
| Features/Payroll/Change Payroll/Menu Text | |

In the following, a structured representation of the configuration items in the data structure is presented, including their respective dimensions shown in brackets.

Features

Edit

Edit Action

| | |
|---|---|
| Enabled: boolean | <Function> |
| Menu Text: string | <Language> |

Fancy Edit Action

| | |
|---|---|
| Enabled: boolean | <Function> |
| Menu Text: string | <Language> |

Macro

Run Macro

| | |
|---|---|
| Enabled: boolean | <Function> |
| Menu Text: string | <Language> |

Edit Macro

| | |
|---|---|
| Enabled: boolean | <Function> |
| Menu Text: string | <Language> |

Control

Manage Users

| | |
|---|---|
| Enabled: boolean | <Function> |
| Menu Text: string | <Language> |

Payroll

View Payroll

| | |
|---|---|
| Enabled: boolean | <Level> |
| Text: string | <Language> |

Change Payroll

| | |
|---|---|
| Enabled: boolean | <Level> |
| Menu Text: string | <Language> |

View

| | |
|---|---|
| Enabled: boolean | <Function> |
| Display: (text, graphical) | <DeviceCaps> |
| Editable: boolean | <DeviceCaps> |
| Size | |

| | |
|---|---|
| Width: integer | <DevicePrefs> |
| Height: integer | <DevicePrefs> |

Tip of the Day

| | |
|---|---|
| Show: boolean | <Default> |

After the configuration program determines the assignments of the respective configuration items, the configuration program determines values for the configuration items by applying rules associated with the dimensions and by taking into consideration parameters identified in those rules (step 308). Therefore, each dimension comprises configuration items that may vary with the same parameters or that may be independent of parameters, as defined by the rule associated with that dimension. In other words, if a dimension is associated with a rule that uses a parameter, all configuration items of that dimension are dependent on that parameter. The configuration program determines the rules associated with each dimension by looking up the rules in a respective assignment database table.

As an example, consider a case in which there are six configuration items A, B, C, D, E, and F. These configuration items are associated with one of three dimensions DIM1, DIM2, and DIM3, as shown below in Table 2. In turn, as shown in Table 2, each dimension is associated with a particular rule RULE1, RULE2, RULE3.

TABLE 2

| Configuration | | |
|---|---|---|
| Item | Dimension | Rule |
| A | DIM1 | RULE1 |
| B | DIM2 | RULE2 |
| C | DIM2 | RULE2 |
| D | DIM1 | RULE1 |
| E | DIM3 | RULE3 |
| F | DIM3 | RULE3 |

In this example, the configuration program may receive none, one or both of a parameter PARA1 and a parameter PARA2 from the client. As shown below in Table 3, these received parameters may be used by a rule. In Table 3, rule RULE1 of dimension DIM1 is not related to a parameter or a parameter combination, that is, the configuration program determines the values for configuration items A and D independent of parameters. Rule RULE2 of dimension DIM2 is defined as taking into consideration parameter PARA1. Rule RULE3 of dimension DIM3 is defined as taking into consideration parameters PARA1 and PARA2.

TABLE 3

| Rule | Rule Definition | Parameters |
|---|---|---|
| RULE1 | A = A | — |
| | D = D | — |
| RULE2 | B = B(PARA1) | PARA1 = <DEFAULT1> |
| | C = C(PARA1) | |
| RULE3 | E = E(PARA1, PARA2) | PARA1 = <DEFAULT1> |
| | F = F(PARA1, PARA2) | PARA2 = <DEFAULT2> |

According to Table 3, the configuration program determines values for configuration items A and D by applying RULE1, which does not use any parameters. The configuration program determines values for configuration items B and C by applying RULE2, which uses parameter PARA1. By applying rule RULE3, the configuration program determines values for configuration items E and F taking into consideration parameters PARA1 and PARA2. As shown for RULE2 and RULE 3, if the client does not transmit one or more of the parameters PARA1 and PARA2, those rules refer to default values <DEFAULT1> and <DEFAULT2> for the missing parameter.

Returning to the illustrative example, the assignment database contains a table identifying the dimensions and their respective configuration items (Table 1 as shown above), a table identifying the dimensions and their associated rules (Table 10 as shown below), and tables identifying the rules and their associated parameters that they use (Tables 13-18 as shown below). The assignment database also contains other tables, as described below, that the rules look to for retrieving configuration item values (Tables 4-12 as shown below). For illustrative purposes, the user, Anna, is one of a group of users that is registered in a user database table (Table 4), in which each user is identified by a User-ID. In Table 4, there are five users identified by the User-ID shown in the column USER-ID of the table. In other words, the group of users in the illustrative example includes Sabine, Martin, Anne, Frank and Peter.

TABLE 4
User Database Table

| USER-ID | RANK | ROLES | LANGUAGES |
|---|---|---|---|
| Sabine | Manager | Admin, PowerUser, User | de, en, fr |
| Martin | Director | User | En |
| Anne | Employee | Developer, PowerUser, User | Fr, de-AT |
| Frank | Manager | Developer, User | De |
| Peter | Employee | PowerUser, User | En, de |

As depicted, Table 4 also has the columns RANK, ROLES, and LANGUAGES. Each column represents one of the fields in the database and also describes, for each individual user, a value for a specific attribute. The attributes are defined for each user to describe specific characteristics or properties of each user within the illustrative example.

For each user, a rank is defined by a respective entry in the column RANK as shown above. For example, user Sabine is of the rank Manager, user Martin is of the rank Director, and user Anne is of the rank Employee. Also, one or more roles are assigned to each user, as indicated by the entries in the column ROLES. For example, the roles Developer and User have been entered in the column ROLES for user Frank. The column LANGUAGES identifies the languages for each user. For example, the languages fr (i.e., the French language) and de-AT (i.e., the German language as spoken in Austria) have been defined for user Anne. The other depicted languages include language de (i.e., the German language) and language en (i.e., the English language). Other languages can also be used, such as language es (i.e., the Spanish language) or language ru (i.e., the Russian language).

As noted above with respect to language de-AT, a dialect of a language or sub-language can be designated. For example, sub-language AT in combination with main language de represents the German language as used and spoken in Austria. Sub-language US in combination with main language en represents the English language as used and spoken in the U.S.A.

In the illustrative example, there is a client device database table in which client devices are registered, as shown in Table 5 below.

TABLE 5
Client Device Database Table

| TYPE | DEVICE CLASS |
|---|---|
| Mobile Phone 1 | CellPhone |
| WebBrowser | PC |
| Mobile Phone 2 | CellPhone |
| Handheld 1 | Handheld |
| Super-TV-Box | SettopBox |
| Video Control | PC |
| Mobile Phone 3 | CellPhone |
| Desktop | PC |
| Palmtop | Handheld |

In the column TYPE of Table 5, several different client devices are indicated by a descriptive term uniquely identifying the client device. However, several client devices of a particular type may be used. For example, user Sabine and Martin may use the cellular phone of the type Mobile Phone 1, however, the client device type is registered one time in the client device database table.

An entry in the column DEVICE CLASS of the client device database table indicates to which device class an individual client device has been assigned. For example, the client device types Mobile Phone 1, Mobile Phone 2, and Mobile Phone 3 are assigned to device class CellPhone, indicating that these client devices are cellular phones or mobile phones (or a similar device that can be assigned to this device class). Similarly, the client devices WebBrowser, Video Control, and Desktop are designed to device class PC, indicating that these client devices are implemented by a computer or software running on a computer. In the example shown above, the client device types Handheld 1 and Palmtop are assigned to the device class Handheld, indicating that client devices of this type are handheld computers. Also, in the illustrative example, the client device type Super-TV-Box is assigned to the device class SettopBox, indicating that client devices of this kind are peripheral devices used in conjunction with, for example, televisions.

It is assumed in the illustrative example that the users, when using any one of the client devices, are users in a framework of the data processing system and require specific configuration data from the configuration program to supply the configuration data to their respective client devices.

In the following, configuration items database tables will be described that store individual data or default data for specific configuration items. The configuration program determines values of configuration items by calling rules that access one or more of these illustrative tables.

In the illustrative example, one of the configuration items database tables is a user preferences database table, as shown in Table 6 below.

TABLE 6
User Preferences Database Table

| USER-ID | CONFIGURATION ITEM | VALUE |
|---|---|---|
| * | Features/Tip of the Day/Show | TRUE |
| Anne | Features/Tip of the Day/Show | FALSE |
| Sabine | Features/Tip of the Day/Show | FALSE |
| Martin | Features/Tip of the Day/Show | FALSE |
| Frank | Features/Tip of the Day/Show | TRUE |

In the column USER-ID of Table 6, a User-ID is stored to identify the user to whom the data stored in the columns CONFIGURATION ITEM and VALUE are assigned. In the first line of the user preferences database table, a symbol * indicates that for each user who cannot be found in the subsequent lines of the user preferences database table, the value of the first line (i.e., TRUE) is assigned as a default value for the configuration item Features/Tip of the Day/Show. Accordingly, for user Peter, the configuration item Features/Tip of the Day Show is set to TRUE by default as Peter is not listed in the user preferences database table. For users Anne, Sabine, and Martin, an entry is shown in the user preferences database table so that the configuration item Features/Tip of the Day/Show is set to FALSE, as shown in the column VALUE of the user preferences database table. Also, for user Frank, an entry is provided in the user preferences database table so that the configuration item Features/Tip of the Day/Show is set to TRUE.

A further database table included in the illustrative example is the device class configuration items database table (Table 7), in which for each device class as defined in the client database table, specific values for the relevant configuration items are given. In the device class configuration items database table, the column DEVICE CLASS identifies the device class as mentioned in the client device database table (Table 5) in the column DEVICE CLASS.

TABLE 7
Device Class Configuration Items Database Table

| DEVICE CLASS | CONFIGURATION ITEM | VALUE |
|---|---|---|
| PC | Features/View/Size/Width | 800 |
| | Features/View/Size/Height | 600 |
| | Features/View/Display | Graphic |
| | Features/View/Editable | TRUE |
| Handheld | Features/View/Size/Width | 200 |
| | Features/View/Size/Height | 50 |
| | Features/View/Display | Graphic |
| | Features/View/Editable | TRUE |
| CellPhone | Features/View/Size/Width | 20 |
| | Features/View/Size/Height | 5 |
| | Features/View/Display | Text |
| | Features/View/Editable | FALSE |
| SettopBox | Features/View/Size/Width | 876 |
| | Features/View/Size/Height | 657 |
| | Features/View/Display | Graphic |
| | Features/View/Editable | FALSE |

For example, in the device class configuration items database table (Table 7), for the device class CellPhone, the configuration item Features/View/Size/Width has the value 20, the configuration item Features/View/Size/Height has the value 5, the configuration item Features/View/Display has the value Text, and the configuration item Features/View/Editable has the value FALSE. These values describe that a client device of the device class CellPhone is provided with a display area having a width of 20 character positions, a height of 5 character positions, and is capable of displaying text. Also, the text displayed in the 20 ×5 display area cannot be edited by the user of a client device of the device class CellPhone.

Further, in the device class configuration items database table (Table 7), for the device class PC, the configuration item Features/view/Size/Width has the value 800, the configuration item Features/View/Size/Height has the value 600, the configuration item Features/View/Display has the value Graphic, and the configuration item Features/View/Editable has the value TRUE. This can be interpreted to describe that a client device of the device class PC is provided with a display area having a width of 800 pixels, a height of 600 pixels, and is capable of displaying graphics. Further, the 800×600 pixel display area allows the user of a client device of the device class PC to edit the information on the display.

The values shown in the device class configuration items database table (Table 7) can be overwritten by values for specific client devices as stored in a client device preferences database table (Table 8), which is shown below.

TABLE 8
Client Device Preferences Database Table

| CLIENT TYPE | CONFIGURATION ITEM | VALUE |
|---|---|---|
| Siemens 4711 | Features/View/Size/Width | 40 |
| | Features/View/Size/Height | 16 |
| Nokia 123 | Features/View/Editable | TRUE |

In the column CLIENT TYPE of Table 8, those client device types are mentioned for which specific configuration data values are different from the values shown in the device class configuration items database table (Table 7) for the respective device class to which the client device type has been assigned in the client database table (Table 5). For example, for the client type Siemens 4721, in the client database table (Table 5), this client type is of the device class CellPhone. Therefore, the device class configuration items database table (Table 7) shows that the values given for the device class CellPhone are used for the configuration items given in column CONFIGURATION ITEM. However, for the client type Siemens 4711, different values are stored for the configuration items as shown in the column CONFIGURATION ITEM of the client device preferences database table (Table 8).

TABLE 9
User Device Preferences Database Table

| USER-ID | CONFIGURATION ITEM | VALUE |
|---|---|---|
| Anne | Features/View/Size/Width | 1024 |
| | Features/view/size/Height | 768 |

In Table 9, in the column USER-ID, the user is identified such that, for any configuration item listed in the column CONFIGURATION ITEM, a user specific value as given in column VALUE can be obtained. Thus, according to Table 9, for user Anne the value 1024 is stored for the configuration item Features/View/Size/Width and the value 768 is stored for the configuration item Features/View/Size/Height.

In the illustrative example, the roles mentioned in the user database table (Table 4) above are linked to configuration items according to the functional roles database table (Table 10) shown below.

TABLE 10
Functional Roles Database Table

| CONFIGURATION ITEM | ROLES |
|---|---|
| Features/Edit/Edit Action/Enabled | PowerUser, User |
| Features/Edit/Fancy Edit Action/Enabled | PowerUser |
| Features/Macro/Run Macro/Enabled | Admin, Developer, PowerUser |
| Features/Macro/Edit Macro/Enabled | Developer |
| Features/Control/Manage Users/Enable | Admin |
| | Admin, Developer, PowerUser, User, |
| Features/View/Enabled | Guest |

For example, the roles Admin, Developer, and PowerUser are linked to the configuration item Features/Macro/Run Macro/Enabled to set this configuration item to TRUE if any one of the roles mentioned in the column ROLES (i.e. Admin, Developer, PowerUser) are assigned to a specific user mentioned in the user database table (Table 4). This link is interpreted to indicate that users having been assigned to any one of the roles Admin, Developer, and PowerUser are allowed to run macros (i.e., execute a specific piece of software). Similarly, users of the role Developer are allowed to edit these macros, as the functional roles database table shows that, for users of the role Developer, the configuration item Features/Macro/Edit Macro/Enabled will be set to TRUE.

Also in the illustrative example, the entry in column RANK of the user database table (Table 4) is related to the column RANK of the required rank database table (Table 11) shown below.

TABLE 11
Required Rank Database Table

| CONFIGURATION ITEM | RANK |
|---|---|
| Features/Payroll/View Payroll/Enabled | Manager |
| Features/Payroll/Change Payroll/Enabled | Director |

The column RANK of the required rank database table (Table 11) defines which entry in the column RANK of the user database table (Table 4) is required to set the configuration item mentioned in column CONFIGURATION ITEM of required rank database table (Table 11) to TRUE.

For example, the configuration item Features/Payroll/View Payroll/Enabled is set to TRUE if the required rank Manager is stored in column RANK of the user database table (Table 4). In the illustrative example, user Sabine has the entry Manager in column RANK of the user database table (Table 4) and is of the rank Manager as shown in the required rank database table (Table 11). Therefore, user Sabine will have the configuration item Features/Payroll/View Payroll/Enabled set to TRUE. This can be interpreted to indicate that user Sabine is entitled to view data of a payroll.

In the illustrative example, a localized data database table (Table 12) contains information concerning language related configuration items which are stored in column CONFIGURATION ITEM of the localized data database table.

TABLE 12
Localized Data Database Table

| CONFIGURATION ITEM | LANGUAGE | TEXT |
|---|---|---|
| Features/Edit/Edit Action/Menu | en | Edit |
| Text | de | Bearbeiten |
| Features/Edit/Fancy Edit | en | Optimise garbage |
| Action/Menu Text | en-US | Optimize garbage |
| | de | Verschnitt optimieren |
| Features/Macro/Run | en | Execute Macro |
| Macro/Menu Text | de | Makro ausfuhren |
| Features/Macro/Edit | en-US | Macro Editor |
| Macro/Menu Text | | |
| Features/Control/Manage | fr | Adminitrer |
| Users/Menu Text | | |
| Features/Payroll/View | de | Gehaltslisten |
| Payroll/Menu Text | de-AT | Lohnkarei |
| | en | View Salaries |
| Features/Payroll/Change | en | Adjust Salaries |
| Payroll/Menu Text | ru | Obrabotat sarplatu |

For each entry in the column CONFIGURATION ITEM of the localized data database table (Table 12), a value designated in column TEXT is defined in accordance with an entry in column LANGUAGE so that, for each configuration item, text can be derived in a specific language.

For example, the configuration item Features/Edit/Fancy Edit Action/Menu Text is defined to have the menu text “Optimise garbage” if the language is en. If the language is en-US, the menu text for configuration item Features/Edit/Fancy Edit Action/Menu Text is set to “Optimize garbage”. If language is de, the menu text is set to “Verschnitt optimieren”.

In the following, the rules will be described for the illustrative example. The configuration program invokes a rule by, for example, calling the rule. The rules can be, for example, functions, subroutines, code pieces, modules, threads, processes or any other software construct that is invoked by the configuration program. The rules are illustratively depicted in the memory, as indicated by item 138, but may alternatively be located in another location, such as in secondary storage. Further, the rules can be a part of the configuration program.

The rules can be modified by, for example, the user or a system administrator to change the dependencies among the configuration items. For example, a system administrator may modify a rule to use different parameters or to retrieve values from different database tables. Therefore, when the configuration program requests a value for a configuration item after a change to a rule, the value may be different than before the rule was changed. Similarly, if the system administrator assigns a configuration item to a new dimension or associates a different rule with the configuration item's dimension, then the configuration item's value may be different after the change.

First, a set of common rules will be described with reference to Table 13. These rules may be used to define further rules.

TABLE 13
Common Rules

| | | | | DATA/ | |
|---|---|---|---|---|---|
| | | | PARAMETERS | RULES | |
| NO | NAME | RESULT | USED | USED | DESCRIPTION |
| RC 1 | Get Rank | Rank | User-ID | User DB | Lookup Rank for parameter |
| | | | | | User-ID in user database |
| | | | | | table (Table 4) |
| RC 2 | Get Device | Device Class | Client Type | Client | Lookup Device Class for |
| | Class | | | Device DB | parameter Client Type in |
| | | | | | client device database table |
| | | | | | (Table 5) |
| RC 3 | Get Roles | Set or Roles | User-ID, | User DB, | Lookup Roles for parameter |
| | | | Connection | Rule 2 | User-ID in user database |
| | | | Properties, Client | | table (Table 4). |
| | | | Type | | Get Device Class for |
| | | | | | parameter Client Type by |
| | | | | | Rule RC 2. |
| | | | | | If parameter Connection |
| | | | | | Properties does not contain |
| | | | | | secure, drop Admin from the |
| | | | | | list of roles. |
| | | | | | If Device Class is not |
| | | | | | Desktop drop Developer |
| | | | | | from the list of roles. |
| | | | | | If Device Class is |
| | | | | | SettopBox drop everything |
| | | | | | but User from the list of |
| | | | | | roles. |
| | | | | | If the list is now empty, |
| | | | | | add role Guest. |
| RC 4 | Get | Accepted | User-ID, | User DB | If parameter Preferred |
| | Accepted | Languages | Preferred | | Language is not given, |
| | Languages | | Language | | lookup Languages for User- |
| | | | | | ID in user database table |
| | | | | | (Table 4). |
| | | | | | Otherwise use the value of |
| | | | | | parameter Preferred |
| | | | | | Language. |
| RC 5 | Order | Higher or | Rank, | — | Check whether parameter |
| | Ranks | lower | level | | Rank is higher or lower than |
| | | | | | parameter Level using the |
| | | | | | following order of levels: |
| | | | | | Visitor |
| | | | | | Intern |
| | | | | | Employee |
| | | | | | Manager |
| | | | | | Director |
| | | | | | Executive |
| RC 6 | Match | Best | Accepted | — | Go through all parameters |
| | Language | Matching | Languages, | | Accepted Language in order |
| | | Available | Available | | of preference. |
| | | Language | Languages | | For each language: |
| | | | | | If the language is matched |
| | | | | | exactly by one of the |
| | | | | | Available Languages, that is |
| | | | | | the best match. |
| | | | | | If the language without |
| | | | | | sublanguage is matched |
| | | | | | exactly by one of the |
| | | | | | Available Languages, that is |
| | | | | | the best match. |
| | | | | | If the language was |
| | | | | | specified without without |
| | | | | | sublanguage and there is at |
| | | | | | least one Available |
| | | | | | Languages differing only by |
| | | | | | sublanguage, that Available |
| | | | | | Languages is the best match |
| | | | | | (an arbitrary one if there is |
| | | | | | more than one). |
| | | | | | Otherwise continue by |
| | | | | | checking the next accepted |
| | | | | | language. |
| | | | | | If no matches have been |
| | | | | | found, try matching the |
| | | | | | default languages “en” in |
| | | | | | the same way. |
| | | | | | If that is not available |
| | | | | | either, one of the Available |
| | | | | | Languages is chosen |
| | | | | | arbitrarily. |

Rules RC1-RC6 that are shown in Table 13 are described below.

Rule RC 1 (Get Rank) uses the parameter User-ID to access the user database table (Table 4) to retrieve the Rank of the user identified by the parameter User-TD. Rule RC 1 returns as a result the Rank as looked up in the user database table (Table 4).

Rule RC 2 (Get Device Class) uses the parameter Client Type to access the client device database table (Table 5) to retrieve the Device Class for the Client Type. Rule RC 2 returns as a result the Device Class as looked up in the client device database table (Table 5).

Rule RC 3 (Get Roles) uses the parameters User-ID, Connection Properties, and Client Type to access the user database table (Table 4) and to apply rule RC 2 using the parameter Client Type. According to rule RC 3, the rule looks up the Roles for the User-ID up in the user database table (Table 4). Further, the rule obtains the Device Class on the basis of the Client Type by calling Rule RC 2. If Connection Properties do not contain “secure”, the rule drops the role Admin from the list of roles which has been looked up previously in the user database table (Table 4). If Device Class is not Desktop, the rule drops the role Developer from the list of roles as looked up in the user database table (Table 4). If the Device Class is SettopBox, all roles but the role User are dropped from the list of roles as looked up in the user database table (Table 4). If the list of roles is now empty, the rule adds the role Guest to the list of roles. Rule RC 3 returns as a result a set of roles.

Rule RC 4 (Get Accepted Languages) uses parameters User-ID and Preferred Language to access the user database table (Table 4). If the parameter Preferred Language is not given, the rule looks up the language for the User-ID in the user database table (Table 4). Otherwise, the rule uses the parameter Preferred Language. Rule RC 4 returns the Accepted Languages as a result.

Rule RC 5 (order Ranks) uses parameters Rank and Level. According to Rule RC 5, the rule checks whether parameter Rank is higher/equal or lower than parameter Level using the order of levels as shown in Table 13. Rule RC 5 returns as a result one of the values higher or lower.

Rule RC 6 (Match Languages) uses parameters Accepted Languages and Available Languages. The rule processes each of the Accepted Languages in the order of preference and for each language the following operations are performed:

If the language is matched to one of the Available Languages, this language is accepted as the best match. For example, if the language is “en-US” (i.e., US English) and one of the available languages is “en-US”, then “en-US” is the best match.

If the language without a sub-language is matched to one of the Available Languages, this language is considered the best match. For example, if the language is “en-US” (i.e., US English) and only “en” (i.e., English) is available as a language, then “en” is considered the best match.

If the language was specified without a sub-language and there is at least one Available Languages differing by sub-language, that language is considered the best match. An arbitrary language is considered the best match if there is more than one. For example, if the language “en” was specified and the available language is “en-US” then “en-US” is considered the best match.

If no matches were found, the default language “en” is used to find the best match in the same way as the previous operation. If a best match cannot be found also on the basis of the default language “en”, one of the available languages is chosen arbitrarily.

In the Table 14, shown below, a set of default rules is illustrated.

TABLE 14
Default Rules

| | | | | DATA/ | |
|---|---|---|---|---|---|
| | | | PARAMETERS | RULES | |
| NO | NAME | RESULT | USED | USED | DESCRIPTION |
| Def 1 | Get | Value or | Key | Config. | Lookup key for User-ID in |
| | User | Nothing | User-ID | Items DB | User preferences |
| | Value | | | | table (Table 7) |
| Def 2 | Get | Value | Key | Config. | Lookup key for User-ID * |
| | Default | | | Items DB | in User preferences |
| | Value | | | | table (Table 7) |
| DEF | Default | Value | Key | Def 1 | Try to get Value for Key by |
| | Value | | User-ID | Def 2 | applying rule Def 1. |
| | | | | | If Def 1 returns no Value, |
| | | | | | get Value for Key by |
| | | | | | applying rule Def 2. |

Rule Def 1 (Get User Value) uses the parameters Key and User-ID to access the user preference database table (Table 6) to retrieve a Value for a specific configuration item for individual users. Rule Def 1 returns a value for a configuration item as looked up in the user preferences database table (Table 6) or nothing.

Rule Def 2 (Get Default Value) uses parameter Key to access the user preferences database table (Table 6) to look up the default value for a specific key and, using the User-ID *, rule Def 2 returns a Value for a configuration item as looked up in the user preferences database table (Table 6).

Rule DEF (Default Value) uses parameters Key and User-ID and applies rules Def 1 and Def 2 to obtain a value for the Key via rule Def 1 to obtain a user specific value or via rule Def 2 to obtain the default value.

In the following Table 15, illustrative device rules are shown:

TABLE 15
Device Rules

| | | | PARA- | DATA/ | |
|---|---|---|---|---|---|
| | | | METERS | RULES | |
| NO | NAME | RESULT | USED | USED | DESCRIPTION |
| Dev 1 | Get | Value or | Key | Config. | Lookup key for User-ID in |
| | User | Nothing | User-ID | Items DB | user device preferences table |
| | Value | | | | (Table 9) |
| Dev 2 | Get | Value or | Key | Config. | Lookup key for Client Type |
| | Default | Nothing | Client Type | Items DB | in client device preference |
| | Value | | | | table (Table 8) |
| Dev 3 | Get | Value | Key | Config. | Get Device Class for Client |
| | Class | | Client Type | Items DB | Type from RC 2. Lookup |
| | Value | | | | Key for Device Class in |
| | | | | RC 2 | Device class configuration |
| | | | | | items table (Table 7). |
| Dev-C | Device | Value | Key | Dev 2 | Try to get Value for Key by |
| | Caps | | Client Type | Dev 3 | applying rule Dev 2. |
| | Value | | | | If Dev 2 returns nothing, try |
| | | | | | to get Value for Key by |
| | | | | | applying rule Dev 3. |
| Dev-P | Device | Value | Key | Dev 1 | Try to get Value for User-ID |
| | Prefs | | User-ID | Dev 2 | and Key by applying rule |
| | Value | | Client Type | Dev 3 | Dev 1. If Dev 1 returns |
| | | | | | nothing, try to get Value for |
| | | | | | Key by applying rule Dev 2. |
| | | | | | If Dev 2 returns nothing, get |
| | | | | | Value for Key by applying |
| | | | | | rule Dev 3. |

Rule Def 1 (Get User Value) uses parameter Key and User-ID to access the user preferences database table (Table 6) to look up configuration items for a specific Key for the given User-ID. Rule Def 1 returns a value for the specific configuration item as looked up in the user preferences database table (Table 6) or nothing.

Rule Dev 2 (Get Device Value) uses parameters Key and Client Type to access the device class configuration items database table (Table 7) to look up a Value for the specific Key and the given client Type. Rule Dev 2 returns a Value for the specific configuration item as looked up in the device class settings database table (Table 7) or nothing.

Rule Dev 3 (Get Class Value) uses parameters Key and Client Type to access the device class configuration items database table (Table 7) and to apply rule RC 2. First, the rule obtains the Device Class by applying rule RC 2 for the specific Client Type. Then, the rule looks up the value for a specific key for the Device Class in the device class configuration items database table (Table 7). Rule Dev 3 returns a value for specific configuration item as looked up in the device class configuration item database table (Table 7).

Rule Dev-C (Device Caps Value) uses parameters Key and Client Type to apply rules Dev 2 and Dev 3. By applying rule Dev 2, the rule obtains a Value for Key. If no value is obtained, rule Dev 3 is applied to obtain a value for Key.

Rule Dev-P (Device Prefs Value) uses parameters Key, User-ID and Client Type to apply rules Dev 1, Dev 2 and Dev 3. First, the rule obtains a Value for Key and for User-ID by applying rule Dev 1. If no Value is obtained, Rule Dev 2 is called to obtain a Value for Key. If again no Value is obtained, Rule Dev 3 is called to obtain a Value for Key. Rule Dev-P returns as a result the Value obtained by applying rules Dev 1, Dev 2, and Dev 3.

TABLE 16
Function Rules

| | | | PARA- | DATA/ | |
|---|---|---|---|---|---|
| | | | METERS | RULES | |
| NO | NAME | RESULT | USED | USED | DESCRIPTION |
| FUNC | Function | Boolean | Key, | Confi. | Get User Roles for the |
| | Enabled | Value | User-ID, | Items DB | parameters by applying rule |
| | | | Connection | RC3 | RC 3. |
| | | | Properties, | | Lookup Enabled Roles for |
| | | | Client Type | | Key in functional roles |
| | | | | | table (Table 10). |
| | | | | | Result is TRUE, if the |
| | | | | | Enabled Roles contain at |
| | | | | | least one of the User Roles, |
| | | | | | and FALSE otherwise. |

In Table 16, a function rule is shown that uses parameters Key, User-ID, Connection Properties, and Client Type to access the functional roles database table (Table 10) and to apply rule RC 3. First, rule FUNC obtains the User Roles for the parameters by applying rule RC 3. Then, rule FUNC looks up the Enabled Roles up for Key in the functional roles database table (Table 10). As rule FUNC is defined to return a boolean value, TRUE is returned as a result if the Enabled Roles contain at least one of the User Roles. Otherwise, FALSE is returned as a result.

TABLE 17
Level Rules

| | | | PARA- | DATA/ | |
|---|---|---|---|---|---|
| | | | METERS | RULES | |
| NO | NAME | RESULT | USED | USED | DESCRIPTION |
| LVL | Level | Boolean | Key, | Config. | Get Rank for User-ID by |
| | Enabled | Value | User-ID | Items DB | applying rule RC 1. |
| | | | | RC 1 | Lookup Required Level for |
| | | | | RC 5 | Key in required rank |
| | | | | | database table (Table 11). |
| | | | | | Compare User Rank to |
| | | | | | Required Level by applying |
| | | | | | rule RC 5. |
| | | | | | Result is TRUE, if the User |
| | | | | | Rank is Higher, FALSE if |
| | | | | | it is Lower. |

In Table 17, level rules are shown. The rule LVL (Level Enabled) uses parameter Key and User-ID to access the required rank database table (Table 11) and to apply rules RC 1 and RC 5. First, by applying Rule RC 1, rule LVL the Rank for a specific User-ID. Then, rule LVL looks up the Required Level for Key in the required rank database table (Table 11). By applying rule RC 5, the User Rank is compared to the required rank and the boolean value TRUE is returned as a result if the User Rank is equal or higher than Required Level. Otherwise, the boolean value FALSE is returned as a result if the User Rank is lower.

TABLE 18
Language Rules

| | | | PARA- | DATA/ | |
|---|---|---|---|---|---|
| | | | METERS | RULES | |
| NO | NAME | RESULT | USED | USED | DESCRIPTION |
| LCL | Language | Value | Key, | Config. | Get Accepted Languages |
| | Value | | User-ID, | Items DB | for the parameters using |
| | | | Preferred | RC 4 | RC 4. |
| | | | Language | RC 6 | Lookup the Available |
| | | | | | Languages present for Key |
| | | | | | in localized data database |
| | | | | | table (Table 12). |
| | | | | | Find the best match for the |
| | | | | | Accepted Languages among |
| | | | | | the Available Language |
| | | | | | using RC 6. |
| | | | | | Lookup the Value for the |
| | | | | | best Language and Key in |
| | | | | | localized data database |
| | | | | | table (Table 12). |

In Table 18, language rules are shown. Rule LCL (Language Value) uses parameters Keys, User-ID, and Preferred Language to access the localized data database table (Table 12) and to apply rules RC 4 and RC 6. By applying rule RC 4, rule LCL obtains the Accepted Languages. Then, rule LCL looks up the Available Languages present for Key in the localized data database table (Table 12). Thereafter, the best match for the Accepted Languages among the Available Languages is found by applying rule RC 6. Finally, a value is looked up for the best Language and Key in the localized data database table (Table 12) and returned as a result of rule LCL.

The following Table 19 describes the association of dimensions and rules, lists the parameters used in the rules, and characterizes the parameter dependency of the dimension by naming the parameter combinations that are used as selectors for the values.

TABLE 19
Dimensions and Rules

| | | | PARAMETER |
|---|---|---|---|
| | RULE | PARAMETER | COMBINATIONS |
| DIMENSION | USED | USED | USED |
| Default | DEF | User-ID | User-ID |
| DeviceCaps | Dev-C | Client Type | Client Type, |
| | | | Device Class |
| DevicePref | Dev-P | User-ID, | User-ID, |
| | | Client Type | Client Type, |
| | | | Device Class |
| Function | FUNC | User-ID, | Rules |
| | | Connection | |
| | | Properties, | |
| | | Client Type | |
| Level | LVL | User-ID | Rank |
| Language | LCL | User-ID, | Accepted |
| | | Preferred | Languages |
| | | Language | |

As shown in Table 19, the dimension Default is associated with rule DEF, the dimension DeviceCaps is associated with rule Dev-C, the dimension DevicePrefs is associated with rule Dev-P, the dimension Function is associated with rule FUNC, the dimension Level is associated with rule LVL, and the dimension Language is associated with rule LCL.

As described above, the configuration program provides values for configuration items, by determining the dimension of each configuration item and, thereafter, determining each rule assigned to each dimension. The configuration program then invokes the respective rules, which return values for the configuration items.

In the following, the illustrative example will be described on the basis of the database tables, rules and dimensions outlined above. It will be apparent how configuration item values for the complete data structure can be obtained for the illustrative set of parameters based on the following description.

For the illustrative example, the received parameters are:

User-ID Anne

Client Type=Palmtop

Connection Properties=(LAN, secure, high-bandwidth, low-latency)

Regarding the dimension Default, the configuration program determines a value for the configuration item Features/Tip of the Day/Show as described below.

According to Table 19, the rule assigned to dimension Default is rule DEF using the parameter User-ID=Anne. According to rule DEF, as shown in Table 14 above, the configuration program provides parameters Key=Features/Tip of the Day/Show and User-ID=Anne to rule DEF. Rule DEF uses these parameters to apply rules Def 1 and Def 2, as described in Table 14 for rule DEF. If rule Def 1 is applied using parameters Key=Features/Tip of the Day/Show and User-ID=Anne, the rule retrieves the boolean value FALSE from the user preferences database table (Table 6). The rule returns this value to the configuration program as a result of rule Def 1, so that rule Def 2 is not applied according to the definition of rule DEF, as shown in Table 14.

Therefore, by associating dimension Default with rule DEV and by providing the parameter User-ID, the configuration program obtains a value for configuration item Features/Tip of the Day/Show, namely the value FALSE as described above.

As shown in Table 19, dimension DeviceCaps is associated with rule Dev-C, parameter Client Type and parameter combination Client Type and Device Class. Dimension DevicePref is associated with rule Dev-P, parameters User-ID and Client Type and parameter combination User-ID, Client Type and Device Class. Dimension Function is associated with rule Dev-P, parameters User-ID, Connection Properties and Client Type and parameter combination Roles. Dimension Level is associated with rule LVL, parameter User-ID and parameter combination rank. And dimension Local is associated with Rule LCL, parameters User-ID and Preferred Languages and parameter combination Accepted Languages.

When the configuration program applies the common rules RC 1 to RC 6 on the basis of the list of parameter values given above (User-ID=Anne, Client Type=Palm, Connection Properties=(LAN, secure, high-bandwidth, low-latency)) the following parameter combinations are obtained:

Accepted Languages=fr, de-AT

Device Class=Handheld

Rank=Employee

Roles=Power User, User

When the configuration program applies the rules associated with the dimensions as shown in Table 19, using the illustrative parameters and parameter combinations, the configuration program determines the following values for the configuration items in the data structure.

Features

Edit

Edit Action

Enabled: TRUE
Text: “Bearbeiten”

Fancy Edit Action

Enabled; TRUE
Text: “Verschnitt optimieren”

Macro

Run Macro

Enabled: TRUE
Text: “Macro aqusfuhren”

Edit Macro

Enabled: FALSE
Text: “Macro Editor”

Control

Manage Users

Enabled: FALSE
Text: “Administrater”

Payroll

View Payroll

Enabled: FALSE
Text: “Lohnkartei”

Change Payroll

Enabled: FALSE
Text: “Adjust Salaries”

View

Enabled: TRUE
Display: graphical
Editable: TRUE
Size

width: 1024
height: 768

Tip of the Day

Show: FALSE

The rules described with respect to the illustrative example are presented as examples. Different rules, even rules with higher complexity may be employed in accordance with methods, systems, and articles of manufacture consistent with the present invention.

After the configuration program determines the values of the configuration items in step 308, the configuration program transmits the determines values to the client (step 310).

Therefore, methods, systems, and articles of manufacture consistent with the present invention provide for introducing new parameters and new dependencies among configuration items without amending the configuration data structure. This flexibility is provided since configuration items are associated with dimensions, which are in turn associated with rules that use parameters that are outside the data structure.

The foregoing description of an implementation of the invention has been presented for purposes of illustration and description. It is not exhaustive and does not limit the invention to the precise form disclosed. Modifications and variations are possible in light of the above teachings or may be acquired from practicing the invention. For example, the described implementation includes software but the present implementation may be implemented as a combination of hardware and software or hardware alone. The invention may be implemented with both object-oriented and non-object-oriented programming systems. The scope of the invention is defined by the claims and their equivalents.

What is claimed is:

1. A method in a configuration server having a program for providing configuration data to a client, the configuration data comprising at least one configuration item having a value, the method comprising the steps of:
receiving a request to provide the value for the configuration item;
determining a set to which the configuration item is assigned, the set being associated with a rule;
determining a value of the configuration item by applying the rule associated with the set; and
transmitting the determined value of the configuration item to the client.

2. The method according to claim 1, further comprising the step of:
receiving at least one parameter from the client.

3. The method according to claim 2, wherein the step of determining a value of the configuration item by applying the rule comprises using the at least one parameter.

4. The method according to claim 1, wherein the step of determining a value of the configuration item by applying the rule comprises using a default value as a parameter.

5. The method according to claim 1, further comprising the step of:
receiving at least one parameter from a plurality of clients.

6. The method according to claim 1, wherein the configuration server receives a plurality of requests to provide a plurality of values to a plurality of clients.

7. The method according to claim 1, wherein the configuration server receives the request to provide the value via a communication network.

8. The method of claim 7, wherein the communication network is the Internet.

9. The method according to claim 1, wherein the configuration item comprises at least one item selected from group of items consisting of: a display size, a display type, and a text string.

10. The method according to claim 2, wherein the at least one parameter is selected from a group of parameters consisting of: a user identification, a role of the user, a rank of the user, a level of the user, a client type, a connection property, and a preferred language.

11. A method in a configuration server having a program for providing configuration data to a client, the configuration data comprising at least one configuration item having a value, the method comprising the steps of:
receiving a user identification information from the client;
receiving a request to provide values of the device type of the client and the display type of the client;
determining one of a plurality of sets to which the device type and the display type are respectively assigned, the sets each being associated with a respective rule;
determining a value of the device type based on the rule associated with the determined set to which the device type is assigned by using the user identification information;
determining a value of the display type based on the rule associated with the set to which the display type is assigned by taking using the user identification information; and
transmitting the determined values of the device type and display type to the client.

12. A computer-readable medium containing instructions that cause a program for providing configuration data to a client, the configuration data comprising at least one configuration item having a value, to perform a method comprising the steps of:
receiving a request to provide the value for the configuration item;
determining a set to which the configuration item is assigned, the set being associated with a rule;
determining a value of the configuration item by applying the rule associated with the set; and
transmitting the determined value of the configuration item to the client.

13. The computer-readable medium according to claim 12, further comprising the step of:
receiving at least one parameter from the client.

14. The computer-readable medium according to claim 13, wherein the step of determining a value of the configuration item by applying the rule comprises using the at least one parameter.

15. The computer-readable medium according to claim 12, wherein the step of determining a value of the configuration item by applying the rule comprises using a default value as a parameter.

16. The computer-readable medium according to claim 12, further comprising the step of:
receiving at least one parameter from a plurality of clients.

17. The computer-readable medium according to claim 12, wherein the configuration server receives a plurality of requests to provide a plurality of values to a plurality of clients.

18. The computer-readable medium according to claim 12, wherein the configuration server receives the request to provide the value via a communication network.

19. The computer-readable medium of claim 18, wherein the communication network is the Internet.

20. The computer-readable medium according to claim 12, wherein the configuration item comprises at least one item selected from group of items consisting of: a display size, a display type, and a text string.

21. The computer-readable medium according to claim 13, wherein the at least one parameter is selected from a group of parameters consisting of: a user identification, a role of the user, a rank of the user, a level of the user, a client type, a connection property, and a preferred language.

22. A computer-readable medium containing instructions that cause a program for providing configuration data to a client, the configuration data comprising at least one configuration item having a value, to perform a method comprising the steps of:
receiving a user identification information from the client;
receiving a request to provide values of the device type of the client and the display type of the client;
determining one of a plurality of sets to which the device type and the display type are respectively assigned, the sets each being associated with a respective rule;
determining a value of the device type based on the rule associated with the determined set to which the device type is assigned by using the user identification information;
determining a value of the display type based on the rule associated with the set to which the display type is assigned by using the user identification information; and
transmitting the determined values of the device type and display type to the client.

23. A configuration server for providing configuration data to a client, the configuration data comprising at least one configuration item having a value, the configuration server comprising:
a memory comprising a program that receives a request to provide the value for the configuration item, determines a set to which the configuration item is assigned, the set being associated with a rule, determines a value of the configuration item by applying the rule associated with the set, and transmits the determined value of the configuration item to the client; and
a processing unit that runs the program.

24. The configuration server according to claim 23, further comprising a storage device for storing the configuration data.

25. The configuration server according to claim 24, wherein the configuration data is stored such that the configuration is assigned to the set.

26. The configuration server according to claim 24, wherein the storage device stores the rule associated with the set.

27. A configuration server for providing configuration data to a client, the configuration data comprising at least one configuration item having a value, the configuration server comprising:
means for receiving a request to provide the value for the configuration item;
means for determining a set to which the configuration item is assigned, the set being associated with a rule;
means for determining a value of the configuration item by applying the rule associated with the set; and
means for transmitting the determined value of the configuration item to the client.

28. A computer-readable memory device encoded with a program having a data structure, the program run by a processor of a configuration server in a data processing system having a client, the data structure having a plurality of entries, each entry comprising:
a configuration item value that is requested by the client and that is returned to the client by determining a set to which the configuration item is assigned, the set being associated with a rule, and determining a value of the configuration item by applying the rule associated with the set.

29. A method in a configuration server having a data structure including a plurality of configuration items, each configuration item having a value, the method comprising the steps of:
receiving from a client a first request to obtain the value for one of the configuration items in the data structure, the data structure having a set of predefined relationships between the data items;
returning to the client the value of the one configuration item;
receiving from the client a second request to obtain the value from the one configuration item in the data structure, the data structure having an additional relationship between the data items that is imposed through a mechanism that is external with respect to the data structure; and
returning to the client the value of the one configuration item.

30. The method according to claim 29, wherein the mechanism is a rule.

31. The method according to claim 29, wherein the mechanism is a parameter.

32. The method according to claim 29, wherein the mechanism is a database entry.

33. The method according to claim 29, wherein the data structure has an existing structure and wherein the step of receiving from the client the second request includes maintaining the existing structure.

34. A computer-readable medium containing instructions that cause a program in a configuration server having a data structure including a plurality of configuration items, each configuration item having a value, to perform a method comprising the steps of:
receiving from a client a first request to obtain the value for one of the configuration items in the data structure, the data structure having a set of predefined relationships between the data items;
returning to the client the value of the one configuration item;
receiving from the client a second request to obtain the value from the one configuration item in the data structure, the data structure having an additional relationship between the data items that is imposed through a mechanism that is external with respect to the data structure; and
returning to the client the value of the one configuration item.

35. A configuration server for providing configuration data to a client, the configuration server having a data structure including a plurality of configuration items, each configuration item having a value, the configuration server comprising:
a memory comprising a program that receives from a client a first request to obtain the value for one of the configuration items in the data structure, the data structure having a set of predefined relationships between the data items, returns to the client the value of the one configuration item, receives from the client a second request to obtain the value from the one configuration item in the data structure, the data structure having an additional relationship between the data items that is imposed through a mechanism that is external with respect to the data structure, and returns to the client the value of the one configuration item; and
a processing unit that runs the program.
